(19) United States
(12) Patent Application Publication
(10) Pub. No.: US 2015/0242822 A1
(43) Pub. Date: Aug. 27, 2015

(54) MAINTENANCE DEVICE, MAINTENANCE SYSTEM, AND MAINTENANCE PROGRAM

(71) Applicant: HITACHI, LTD., Chiyoda-ku,Tokyo (JP)

(72) Inventors: Hiroyuki Magara, Tokyo (JP); Toshiharu Miwa, Tokyo (JP); Yuuki Hara, Tokyo (JP); Toshiaki Kono, Berkshire (GB)

(21) Appl. No.: 14/435,727

(22) PCT Filed: Oct. 9, 2013
(86) PCT No.: PCT/JP2013/077428

§ 371 Date: Apr. 14, 2015

(30) Foreign Application Priority Data
Oct. 19, 2012 (JP) 2012-231403

(51) Int. Cl. G06Q 10/00; G08B 21/18

(52) U.S. Cl. CPC G06Q 10/20; G08B 21/18

(57) ABSTRACT

Provided is a technology for assisting quick preparation of a maintenance plan. A maintenance device includes: a maintenance operation identification part configured to acquire, for an alarm received via a network, from another device that has transmitted the alarm via the network, information for identifying the alarm and information output from a sensor causing generation of the alarm, and extract required maintenance operations based on the information for identifying the alarm and the information output from the sensor; a constraint information identification part configured to identify constraint information including a facility required for each of the required maintenance operations; and an optimal operation plan calculation part configured to identify an execution order of the required maintenance operations based on a priority order in the constraint information, and assign predetermined time zones, to thereby generate a maintenance operation plan.

### TECHNICAL FIELD

The present invention relates to a maintenance device. The present invention claims priority to Japanese Patent Application No. 2012-231403 filed on Oct. 19, 2012, the contents of which are incorporated herein by reference in its entirety for the designated states where incorporation by reference of literature is allowed.

### BACKGROUND ART

One example of the background art in this technical field is disclosed in Japanese Patent Laid-open Publication No. 2002-165313 (Patent Literature 1). In Patent Literature 1, there is a description that “when failure information is transmitted from a train to a ground facility, the information is analyzed and processed in the train in accordance with different transmission destinations, and necessary information is transmitted”.

### CITATION LIST

### Patent Literature

[PTL 1] Japanese Patent Laid-open Publication No. 2002-165313

### SUMMARY OF INVENTION

### Technical Problem

The above-mentioned technology can reduce a communication capacity and an amount of information processing carried out by the ground facility, but cannot assist the quick preparation of a maintenance plan based on the transmitted information. It is important for a system for carrying out maintenance not only to collect failure information but also to quickly carryout recovery from the failure thereafter for a normal operation. However, when a failure occurs, recovery from the failure is particularly urgent, and preparation of a maintenance operation plan is thus often delayed.

It is an object of the present invention to provide a technology for assisting quick preparation of a maintenance plan.

### Solution to Problem

In order to solve the above-mentioned problem, according to one embodiment of the present invention, there is provided a maintenance device, including: a maintenance operation identification part configured to acquire, for an alarm received via a network, from another device that has transmitted the alarm via the network, information for identifying the alarm and output information from a sensor causing generation of the alarm, and extract required maintenance operations based on the information for identifying the alarm and the output information from the sensor; a constraint information identification part configured to identify constraint information including a facility required for each of the required maintenance operations; and an optimal operation plan calculation part configured to identify an execution order of the required maintenance operations based on a priority order in the constraint information, and assign predetermined time zones, to thereby generate a maintenance operation plan.

### Advantageous Effects of Invention

According to the one embodiment of the present invention, quick preparation of the maintenance plan may be assisted. Objects, configurations, and effects other than those described above become more apparent from the following description of an embodiment of the present invention.

### BRIEF DESCRIPTION OF DRAWINGS

FIG. 1 is a diagram illustrating a configuration example of an entire maintenance service according to an embodiment of the present invention.

FIG. 2 is a diagram illustrating a configuration example of a maintenance system according to the embodiment of the present invention.

FIG. 3 is a diagram illustrating a data structure stored in a sensor information storage part.

FIG. 4 is a diagram illustrating a data structure stored in an alarm information storage part.

FIG. 5 is a diagram illustrating a data structure stored in a causality structure storage part.

FIG. 6 is a diagram illustrating a data structure stored in a maintenance operation resource storage part.

FIG. 7 is a diagram illustrating a data structure stored in a constraint information storage part.

FIG. 8 is a diagram illustrating a data structure stored in an optimal operation order list storage part.

FIG. 9 is a diagram illustrating a data structure stored in a waiting operation list storage part.

FIG. 10 is a diagram illustrating a data structure stored in a vehicle assignment request time/date information storage part.

FIG. 11 is a diagram illustrating a data structure stored in a scheduling rule storage part.

FIG. 12 is a diagram illustrating a data structure stored in an optimal operation plan information storage part.

FIG. 13 is diagram illustrating a hardware configuration of a maintenance operation plan calculation device.

FIG. 14 is a chart illustrating a processing flow of maintenance plan processing.

FIG. 15 is a chart illustrating a processing flow of processing of extracting maintenance operations.

FIG. 16 is a chart illustrating a processing flow of a constraint condition identification processing.

FIG. 17 is a chart illustrating a processing flow of optimal operation plan calculation processing.

### DESCRIPTION OF EMBODIMENTS

Now, a description is made of a railroad maintenance system 1 serving as an example of a system functioning as a maintenance system according to a first embodiment of the present invention with reference to the accompanying drawings.

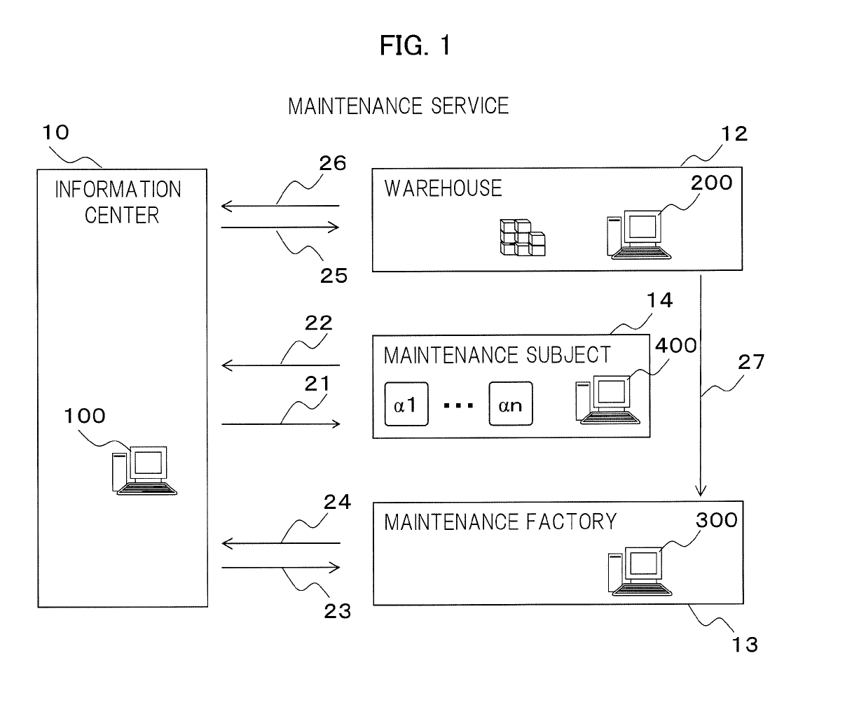

FIG. 1 is a diagram illustrating a configuration example of the entire maintenance service according to the present invention. This maintenance service includes an information center 10, a warehouse 12, a maintenance factory 13, and a maintenance subject 14.

In general, in order to maintain a quality of moving bodies such as railroads, airplanes, ships, buses, and taxies for a long period, it is necessary to appropriately carryout a maintenance operation such as component replacement in advance periodically or depending on a failure generation risk. Moreover, when a service form of guaranteeing an operation rate or a quality more than a certain level exists in a maintenance contract, it is a problem how to precisely and efficiently carry out required maintenance operations such as the component replacement, how to reduce a maintenance component cost and an operation cost, and how to increase profitability.

Moreover, in the maintenance of moving bodies such as railroads, airplanes, and ships, an introduction of, in addition to a maintenance method centered around a time based maintenance (TEM), a condition based maintenance (CBM) based on analysis of data acquired from sensors installed on vehicle bodies and the like has been considered in order to reduce the maintenance cost. As a result, the conventional maintenance operation such as the component replacement and repair carried out based on a standard set on a safe side can be suppressed to a required minimum frequency depending on the state. However, on the other hand, whether or not the maintenance operation is necessary is determined after the state is diagnosed in the CBM. Thus, an actual operation period with respect to a maintenance operation plan prepared in advance tends to vary, resulting in a problem of a delay of the plan or an extra waiting period.

Therefore, in order to efficiently manage them, the information center 10 for managing information required for the maintenance of the maintenance subject 14 is provided, to thereby realize a maintenance service.

At least one maintenance operation plan calculation device 100 is provided in the information center 10, to thereby receive alarm information 22 periodically or unpredictably notified from a plurality of vehicles α1, α2, . . . , αn (n is a positive integer), which are the maintenance subject 14. Moreover, the information center 10 requests detailed sensor information from the maintenance subject 14, calculates a maintenance operation plan based on the sensor information, and distributes a maintenance operation plan 25 and a maintenance operation plan 23 respectively to the warehouse 12 and the maintenance factory 13.

At least one display terminal 200 is provided in the warehouse 12, to thereby receive the maintenance operation plan 25 transmitted from the information center 10, Thus, the maintenance operation plan 25 can be referred to on the warehouse 12 side. Moreover, the warehouse 12 ships a maintenance component 27 required for the maintenance operation included in the maintenance operation plan 25 to the maintenance factory 13.

At least one display terminal 300 is provided in the maintenance factory 13, to thereby receive the maintenance operation plan 23 transmitted from the information center 10. Thus, the maintenance operation plan 23 can be referred to on the maintenance factory 13 side. In the maintenance factory 13, facilities and man power included in the maintenance operation plan 23 are adjusted, and the maintenance component 27 shipped from the warehouse 12 is received, to thereby carry out the maintenance operation for the maintenance subject 14. It should be noted that a plurality of maintenance factories 13 may be arranged for respective service lines of the maintenance subjects 14.

As least one sensor data management device 400 is provided for the maintenance subject 14, to thereby acquire values acquired from various sensors installed on the maintenance subject 14 such as the vehicle al, and determine whether or not the maintenance subject 14 is in an abnormal state. When the maintenance subject 14 is in the abnormal state, the maintenance subject 14 transmits the alarm information 22 including a predetermined alarm ID based on the state to the information center 10. Moreover, the maintenance subject 14 receives a read request 21 for the sensor information from the information center 10, and provides the sensor information to the information center 10.

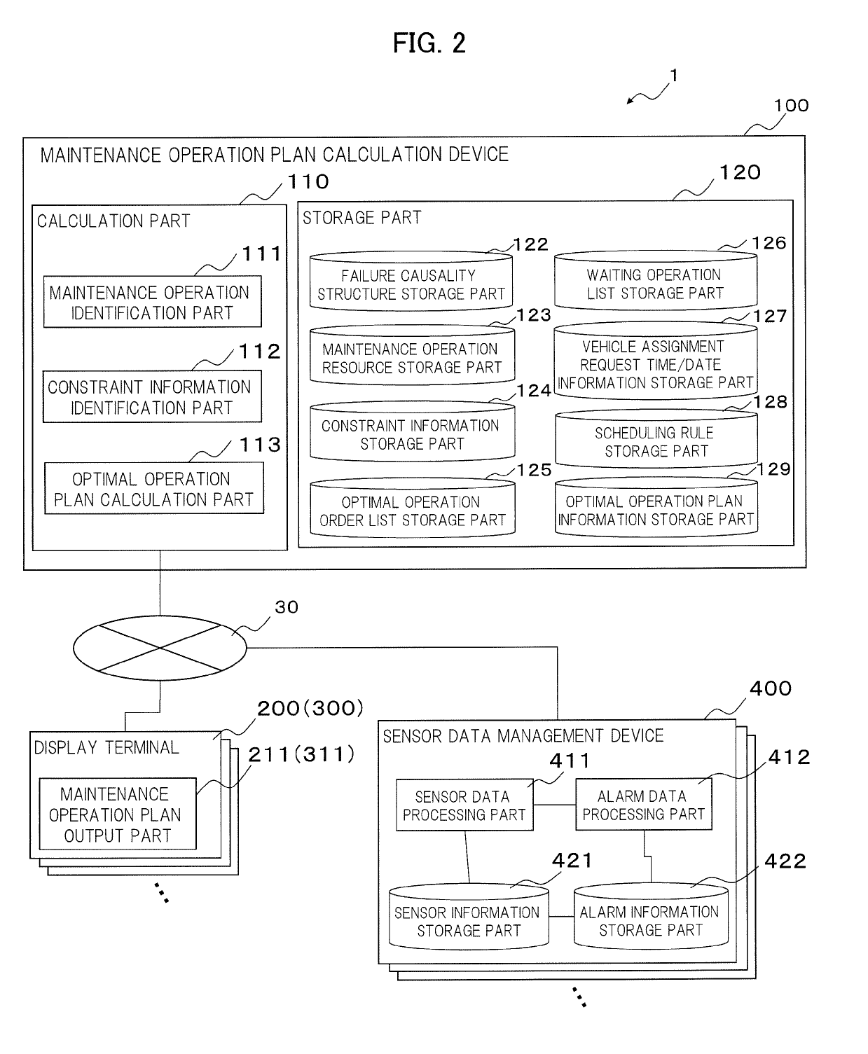

FIG. 2 is a diagram illustrating the railroad maintenance system 1 according to the first embodiment of the present invention. The railroad maintenance system 1 according to the present invention includes the maintenance operation plan calculation device 100, the display terminals 200 and 300 capable of communicating to/from the maintenance operation plan calculation device 100 via a network 30 including local area networks (LANs), wide area networks (WANs), and virtual private networks (VPNs), and the sensor data management device 400. One or a plurality of maintenance operation plan calculation devices 100 are arranged in the information center 10, one or a plurality of display terminals 200 and 300 are arranged respectively in the warehouse 12 and the maintenance factory 13, and one or a plurality of sensor data management devices 400 are arranged on respective trains α1, α2, . . . , αn.

The maintenance operation plan calculation device 100 includes at least a calculation part 110 and a storage part 120. The calculation part 110 includes a maintenance operation identification part 111, a constraint information identification part 112, and an optimal operation plan calculation part 113. Moreover, the storage part 120 includes a failure causality structure storage part 122, a maintenance operation resource storage part 123, a constraint information storage part 124, an optimal operation order list storage part 125, a waiting operation list storage part 126, a vehicle assignment request time/date information storage part 127, a scheduling rule storage part 128, and an optimal operation plan information storage part 129.

The display terminal 200 includes a maintenance operation plan output part 211. It should be noted that the display terminal 300 similarly includes a maintenance operation plan output part 311.

The sensor data management device 400 includes a sensor data processing part 411, an alarm data processing part 412, a sensor information storage part 421, and an alarm information storage part 422.

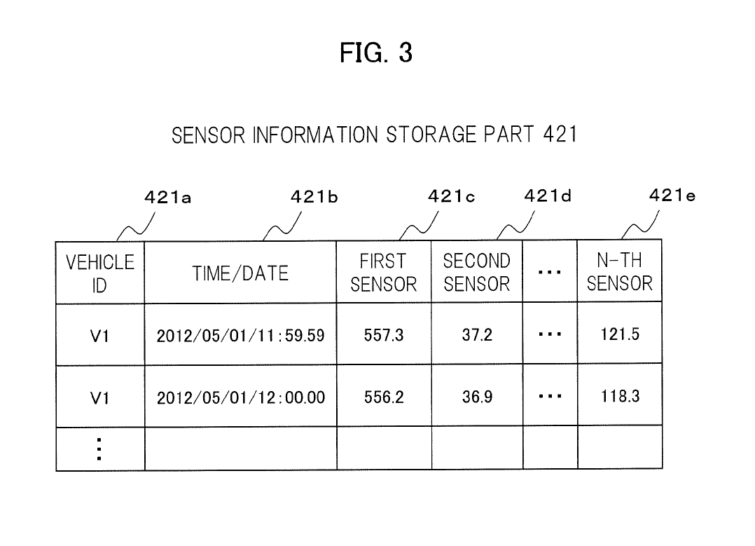

FIG. 3 is a diagram illustrating a structure of data stored in the sensor information storage part 421 of the sensor data management device 400. The sensor information storage part 421 stores a vehicle ID 421a, a time/date 421b, a first sensor 421c, a second sensor 421d, and an N-th (N is a positive integer) sensor 421e.

The vehicle ID 421a stores information for identifying a vehicle on which sensors are installed. The time/date 421b stores information for identifying a time/date when data is received from the sensors. The first sensor 421c stores information for identifying an output from a predetermined first sensor that provides information. The second sensor 421d stores information for identifying an output from a predetermined second sensor that provides information. The N-th sensor 421e stores information for identifying an output from a predetermined N-th (N is a positive integer) sensor that provides information.

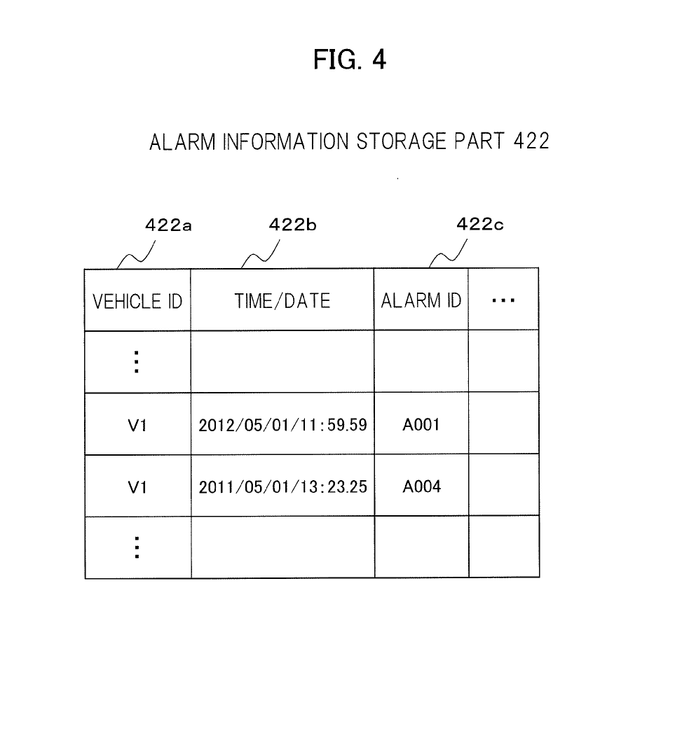

FIG. 4 is a diagram illustrating a structure of data stored in the alarm information storage part 422 of the sensor data management device 400. The alarm information storage part 422 stores a vehicle ID 422a that is information for identifying a vehicle transmitting an alarm, a time/date 422b that is information for identifying a time/date when the alarm is transmitted, and an alarm ID 422c that is information for identifying a type of the transmitted alarm.

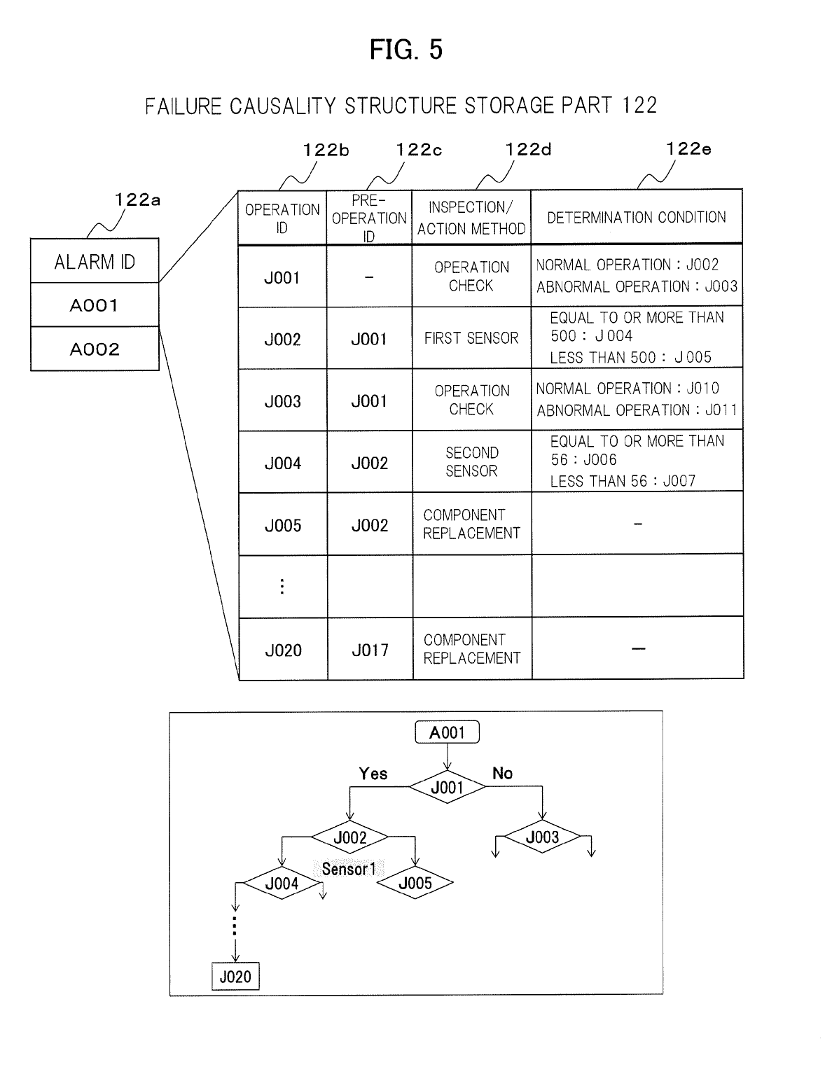

FIG. 5 is a diagram illustrating a structure of data stored in the failure causality structure storage part 122 of the maintenance operation plan calculation device 100. The failure causality structure storage part 122 stores, for each of alarm IDs 122a for identifying a type of the alarm, an operation ID 122b, a pre-operation ID 122c, an inspection/action method 122d, and a determination condition 122e associated one another in advance. In other words, the failure causality structure storage part 122 stores failure causality structure information in which one or a plurality of maintenance operations are associated with the information for identifying the alarm. Moreover, in the failure causality information, the predetermined condition is associated with the maintenance operation for which a subsequent operation exists when the output information from the sensor satisfies the predetermined condition.

The operation ID 122b stores information for identifying a maintenance operation to be carried out. The pre-operation ID 122c stores information for identifying a maintenance operation constituting a prerequisite of the maintenance operation identified by the operation ID 122b. The inspection/action method 122d stores information for identifying an action required for identifying other maintenance operations to be carried out along with the maintenance operation identified by the operation ID 122b or information to be referred to. The determination condition 122e stores information for identifying subsequent maintenance operations to be carried out depending on a result of the action or the reference in the inspection/action method 122d.

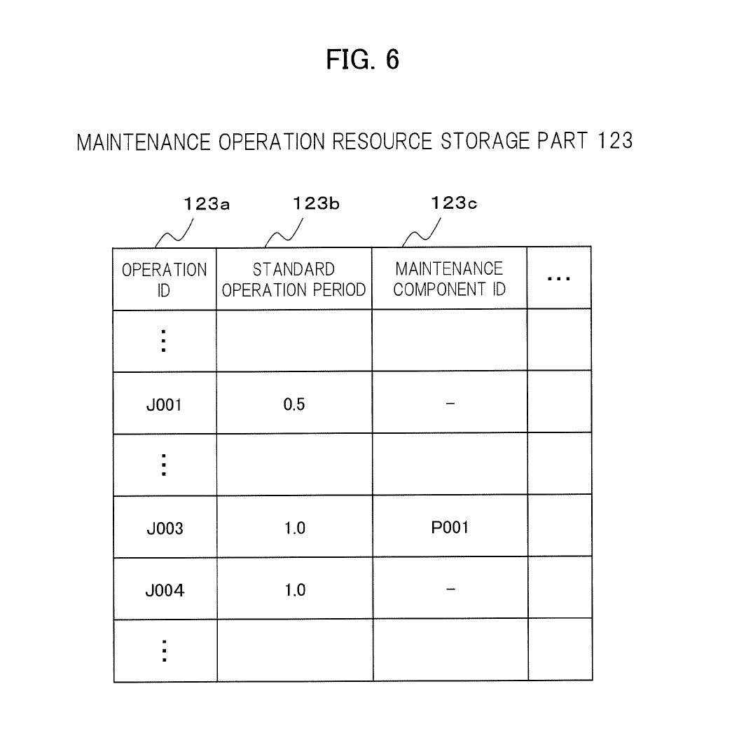

FIG. 6 is a diagram illustrating a structure of data stored in the maintenance operation resource storage part 123 of the maintenance operation plan calculation device 100. The maintenance operation resource storage part 123 stores an operation ID 123a for identifying a maintenance operation, a standard operation period 123b that is information for identifying a standard required period of the maintenance operation identified by the operation ID 123a, and a maintenance component ID 123c that is information for identifying a replacement component or the like required for the maintenance operation identified by the operation ID 123a.

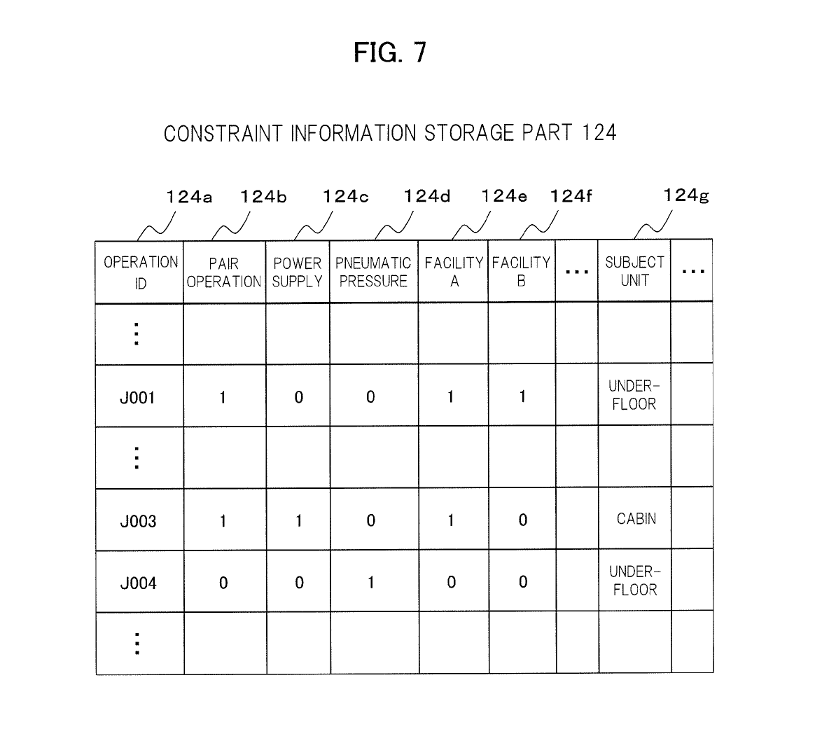

FIG. 7 is a diagram illustrating a structure of data stored in the constraint information storage part 124 of the maintenance operation plan calculation device 100. The constraint information storage part 124 stores an operation ID 124a, a pair operation 124b, a power supply 124c, a pneumatic pressure 124d, a facility A 124e, a facility B 124f, and a subject unit 124g.

The operation ID 124a stores information for identifying a maintenance operation. The pair operation 124b stores information for identifying whether or not the maintenance operation identified by the operation ID 124a is an operation requiring two or more workers. The power supply 124c stores information for identifying whether or not a power supply of the vehicle needs to be turned on for the operation required in the maintenance operation identified by the operation ID 124a.

The pneumatic pressure 124d stores information for identifying whether or not a pneumatic pressure of the vehicle needs to be turned on for the operation required in the maintenance operation identified by the operation ID 124a. The facility A 124e stores information for identifying whether or not a predetermined facility A is necessary for the operation required in the maintenance operation identified by the operation ID 124a. The facility B 124f stores information for identifying whether or not a predetermined facility B is necessary for the operation required in the maintenance operation identified by the operation ID 124a. The subject unit 124g stores information for identifying a portion set as a maintenance subject in the maintenance operation identified by the operation ID 124a.

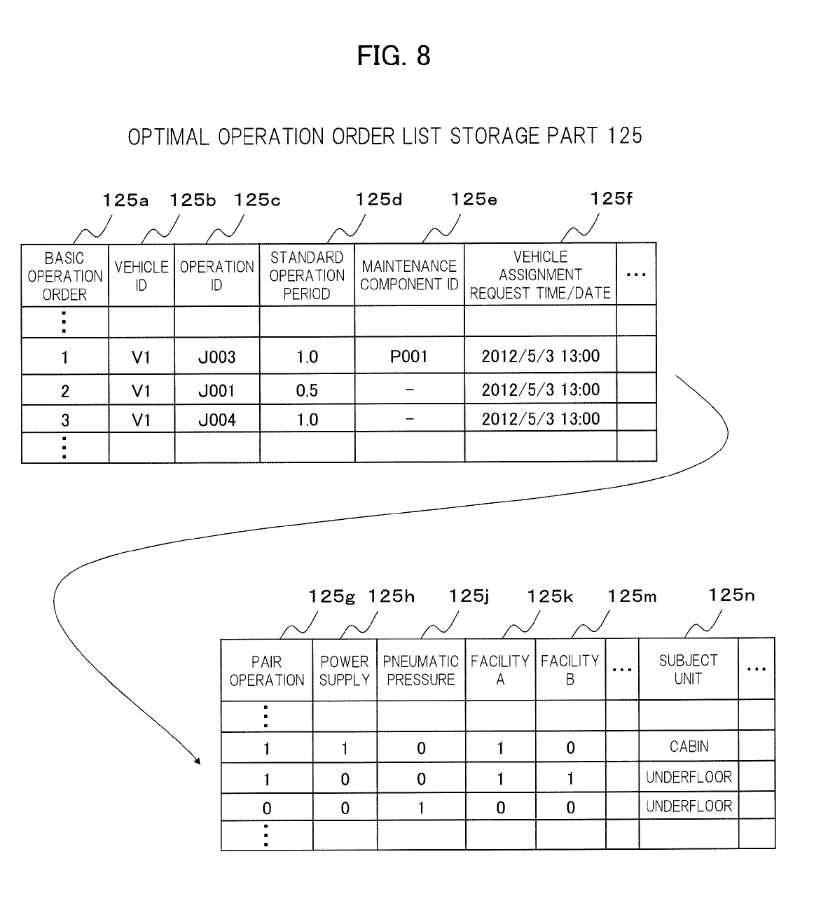

FIG. 8 is a diagram illustrating a structure of data stored in the optimal operation order list storage part 125 of the maintenance operation plan calculation device 100. The optimal operation order list storage part 125 stores a basic operation order 125a, a vehicle ID 125b, an operation ID 125c, a standard operation period 125d, a maintenance component ID 125e, a vehicle assignment request time/date 125f, a pair operation 125g, a power supply 125h, a pneumatic pressure 125j, a facility A 125k, a facility B 125m, and a subject unit 125n.

The basic operation order 125a stores information for identifying a basic order of a maintenance operation. The vehicle ID 125b stores information for identifying a vehicle subject to the maintenance operation. The operation ID 125c stores information for identifying a maintenance operation to be carried out. The standard operation period 125d stores information for identifying a standard required period of the maintenance operation. The maintenance component ID 125e stores information for identifying a replacement component or the like required for the maintenance operation. The vehicle assignment request time/date 125f stores information for identifying a time/date when the operation of the vehicle identified by the vehicle ID 125b is resumed.

The pair operation 125g stores information for identifying whether or not the maintenance operation identified by the operation ID 125c is an operation requiring two or more workers. The power supply 125h stores information for identifying whether or not the power supply of the vehicle needs to be turned on for the operation required in the maintenance operation identified by the operation ID 125c. The pneumatic pressure 125j stores information for identifying whether or not the pneumatic pressure of the vehicle needs to be turned on for the operation required in the maintenance operation identified by the operation ID 125c. The facility A 125k stores information for identifying whether or not a predetermined facility A is necessary for the operation required in the maintenance operation identified by the operation ID 125c. The facility B 125m stores information for identifying whether or not a predetermined facility B is necessary for the operation required in the maintenance operation identified by the operation ID 125c. The subject unit 125n stores information for identifying a portion set as a maintenance subject in the maintenance operation identified by the operation ID 125c.

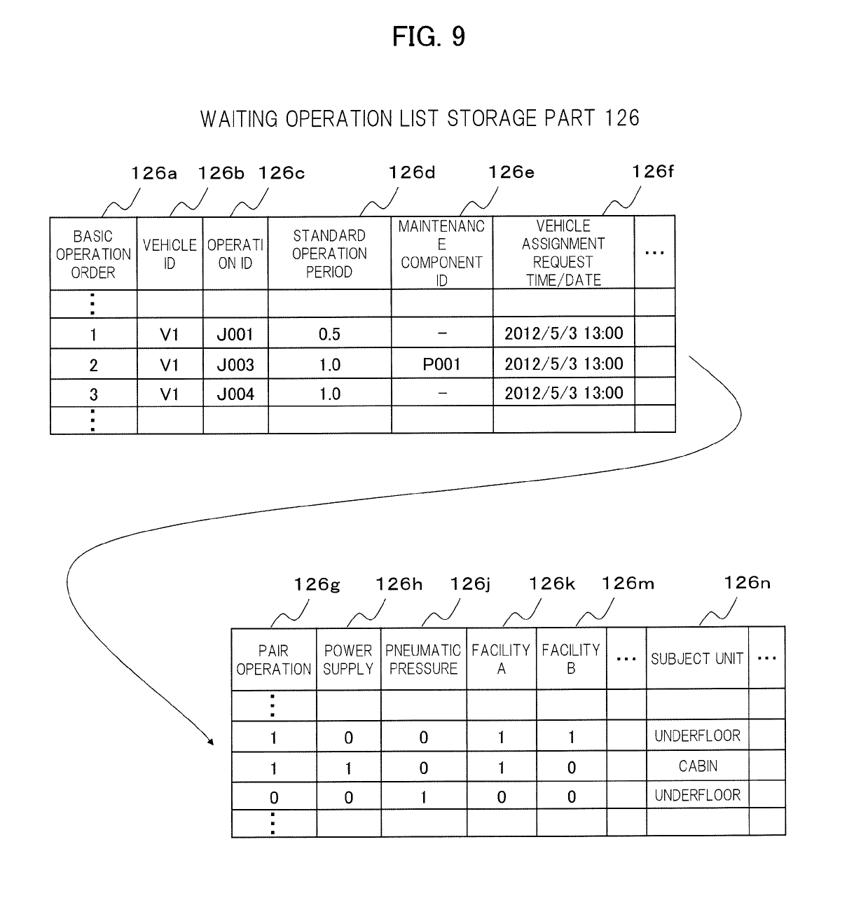

FIG. 9 is a diagram illustrating a structure of data stored in the waiting operation list storage part 126 of the maintenance operation plan calculation device 100. The waiting operation list storage part 126 stores a basic operation order 126a, a vehicle ID 126b, an operation ID 126c, a standard operation period 126d, a maintenance component ID 126e, a vehicle assignment request time/date 126f, a pair operation 126g, a power supply 126h, a pneumatic pressure 126j, a facility A 126k, a facility B 126m, and a subject unit 126n.

The basic operation order 126a stores information for identifying a basic order of a maintenance operation. The vehicle ID 126b stores information for identifying a vehicle subject to the maintenance operation. The operation ID 126c stores information for identifying a maintenance operation to be carried out. The standard operation period 126d stores information for identifying a standard required period of the maintenance operation. The maintenance component ID 126e stores information for identifying a replacement component or the like required for the maintenance operation. The vehicle assignment request time/date 126f stores information for identifying a time/date when the operation of the vehicle identified by the vehicle ID 126b is resumed.

The pair operation 126g stores information for identifying whether or not the maintenance operation identified by the operation ID 126c is an operation requiring two or more workers. The power supply 126h stores information for identifying whether or not the power supply of the vehicle needs to be turned on for the operation required in the maintenance operation identified by the operation ID 126c. The pneumatic pressure 126j stores information for identifying whether or not the pneumatic pressure of the vehicle needs to be turned on for the operation required in the maintenance operation identified by the operation ID 126c. The facility A 126k stores information for identifying whether or not a predetermined facility A is necessary for the operation required in the maintenance operation identified by the operation ID 126c. The facility B 126m stores information for identifying whether or not a predetermined facility B is necessary for the operation required in the maintenance operation identified by the operation ID 126c. The subject unit 126n stores information for identifying a portion set as a maintenance subject in the maintenance operation identified by the operation ID 126c.

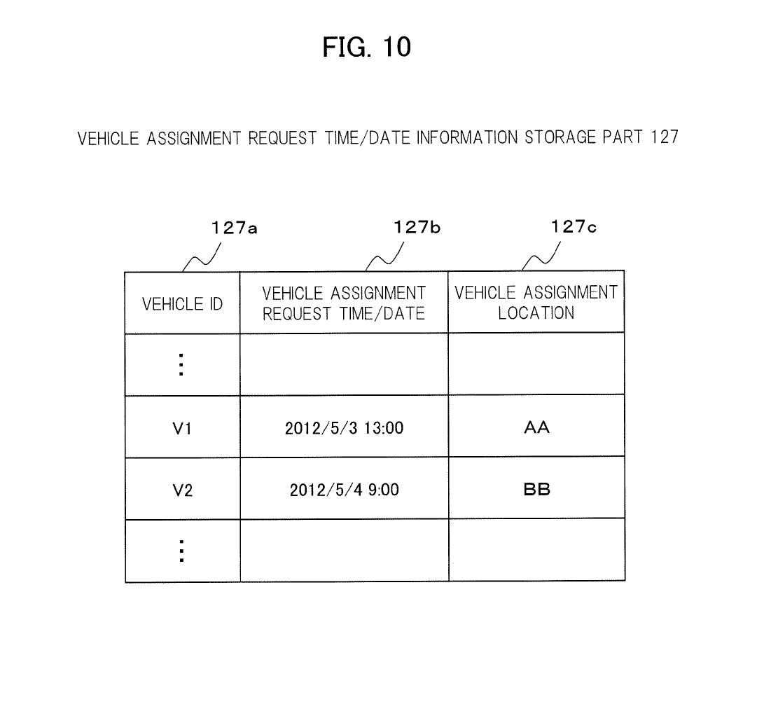

FIG. 10 is a diagram illustrating a structure of data stored in the vehicle assignment request time/date information storage part 127 of the maintenance operation plan calculation device 100. The vehicle assignment request time/date information storage part 127 stores a vehicle ID 127a that is information for identifying a vehicle, a vehicle assignment request time/date 127b that is information for identifying a time/date when the operation of the vehicle identified by the vehicle ID 127a is resumed, and a vehicle assignment location 127c that is information for identifying a location at which the operation of the vehicle identified by the vehicle ID 127a is resumed.

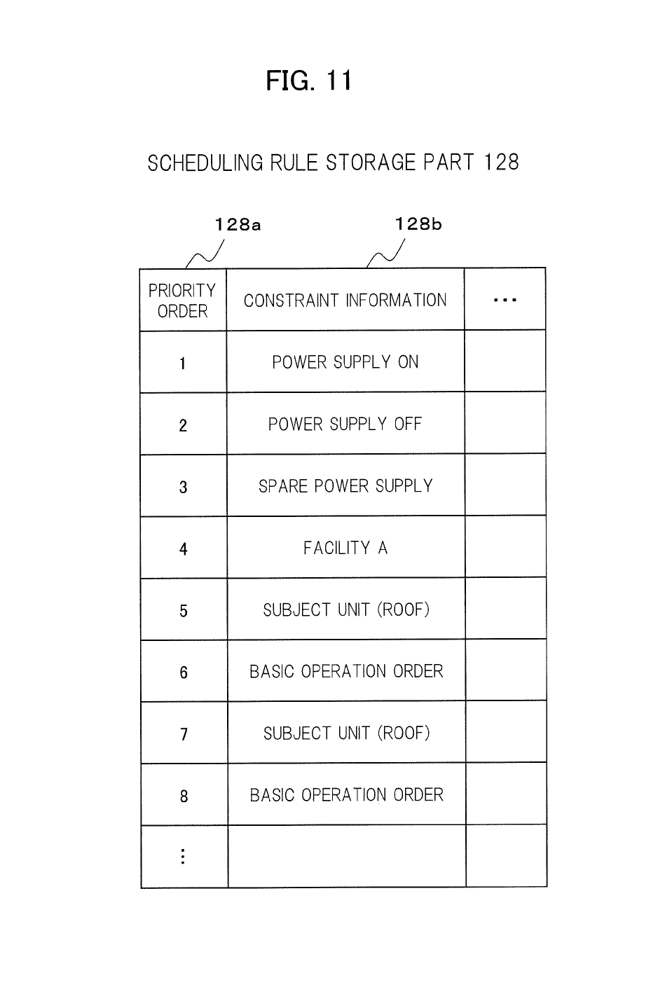

FIG. 11 is a diagram illustrating a structure of data stored in the scheduling rule storage part 128 of the maintenance operation plan calculation device 100. The scheduling rule storage part 128 stores a priority order 128a that is information for identifying the order of priority of an operation, and constraint information 128b for identifying a constraint condition of the operation in priority. In other words, the scheduling rule storage part 128 stores information including the priority order among types of the constraint included in the constraint information.

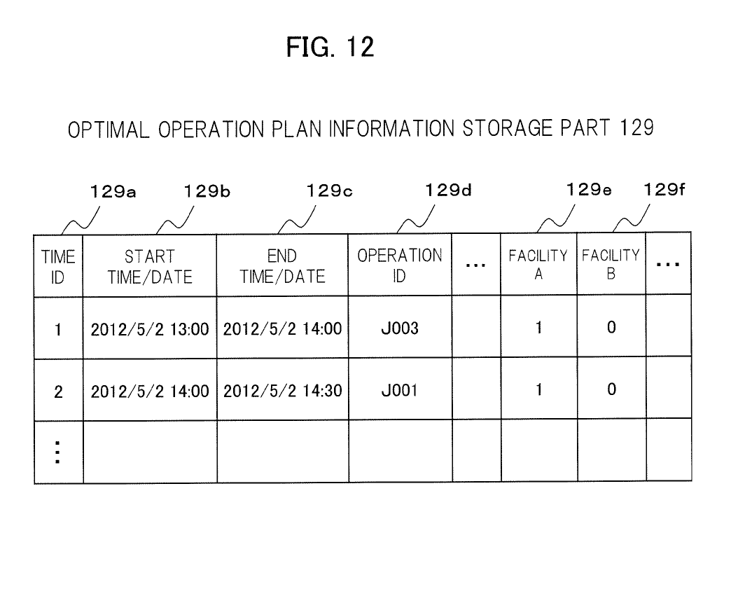

FIG. 12 is a diagram illustrating a structure of data stored in the optimal operation plan information storage part 129 of the maintenance operation plan calculation device 100. The optimal operation plan information storage part 129 stores a time ID 129a, a start time/date 129b, an end time/date 129c, an operation ID 129d, a facility A 129e, and a facility B 129f.

The time ID 129a stores information for identifying a time zone. The start time/date 129b stores information for identifying a start time/date in the time zone identified by the time ID 129a. The end time/date 129c stores information for identifying an end time/date in the time zone identified by the time ID 129a. The operation ID 129d stores information for identifying a maintenance operation carried out in the time zone identified by the time ID 129a. The facility A 129e stores information for identifying whether or not a predetermined facility A is necessary in the maintenance operation identified by the operation ID 129d. The facility B 129f stores information for identifying whether or not a predetermined facility B is necessary in the maintenance operation identified by the operation ID 129d.

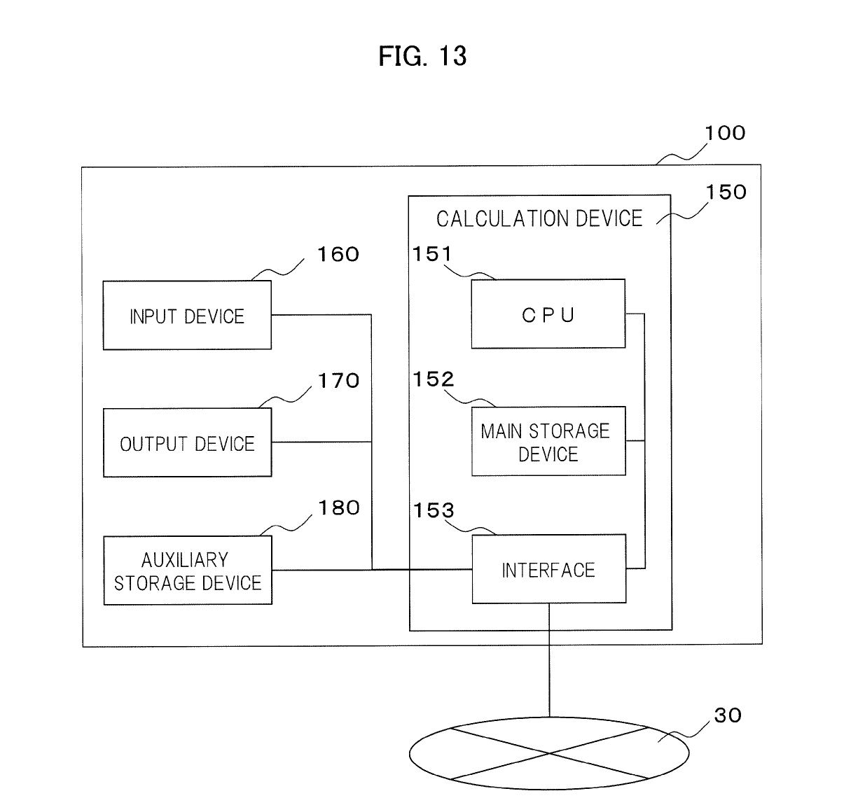

FIG. 13 is a diagram illustrating a hardware configuration example of the maintenance operation plan calculation device 100. The maintenance operation plan calculation device 100 is typically a personal computer device, but is not limited to the personal computer device, and may be an electronic information terminal such as a cellular phone terminal or a personal digital assistant (PDA). Moreover, the maintenance operation plan calculation device 100 may not make a direct access to the network 30, and may make an access to the network 30 via a communication network based on the line switching such as a cellular phone carrier, a wireless communication network for data transmission, or the like.

The maintenance operation identification part 111 of the maintenance operation plan calculation device 100 acquires the alarm ID and the sensor information, to thereby extract required maintenance operations. More specifically, the maintenance operation identification part 111 acquires, for an alarm received via a network, from another device that has transmitted the alarm via the network, information for identifying the alarm, and output information from a sensor causing generation of the alarm, and extracts required maintenance operations based on the information for identifying the alarm and the output information from the sensor.

The constraint information identification part 112 identifies the constraint information including facilities required for each of the required maintenance operations. Moreover, the optimal operation plan calculation part 113 identifies the execution order of maintenance operations based on the priority order in the constraint information, and assigns predetermined time zones, to thereby generate a maintenance operation plan. It should be noted that detailed operations of the maintenance operation identification part 111, the constraint information identification part 112, and the optimal operation plan calculation part 113 are described in a processing flow of maintenance plan processing described later.

The maintenance operation plan output part 211 of the display terminal 200 refers to the maintenance operation plan, and constructs and outputs output screen information and output document information. The same applies to the maintenance operation plan output part 311 of the display terminal 300.

The sensor data processing part 411 of the sensor data management device 400 acquires output information from predetermined sensors installed on predetermined locations of the vehicle, quantifies the output information, and stores the quantified information in the sensor information storage part 421. The alarm data processing part 412 determines whether or not the output information from the sensors is abnormal. When the alarm data processing part 412 detects an abnormality corresponding to a combination of values of predetermined sensors, the alarm data processing part 412 assigns, to the abnormality, an alarm ID or the like corresponding to the abnormality, and stores alarm information in the alarm information storage part 422. Moreover, the alarm data processing part 412 transmits the alarm information including the vehicle ID on which the abnormality has occurred and the alarm ID to the maintenance operation plan calculation device 100 via the network 30. It should be noted that when an external device such as the maintenance operation plan calculation part 100 requests the sensor data processing part 411 to provide sensor information, the sensor data processing part 411 returns corresponding output information from a sensor in the sensor information storage part 421 as a reply. Moreover, when an external device such as the maintenance operation plan calculation part 100 requests the alarm data processing part 412 to provide alarm information, the alarm data processing part 412 returns corresponding output information from a sensor in the alarm information storage part 422 as a reply.

The maintenance operation plan calculation device 100 includes a calculation device 150, an input device 160, an output device 170, an auxiliary storage device 180, and a bus for connecting those devices. The calculation device 150 includes a central processing unit (CPU) 151, a main storage device 152, and an interface 153.

The main storage device 152 is, for example, a memory device such as a random access memory (RAM).

The interface 153 is a wired communication device for carrying out wired communication via a network cable or a wireless communication device for carrying out wireless communication via an antenna. The interface 153 communicates to/from devices connected to networks such as the network 30.

The input device 160 is a device for receiving input information including a pointing device such as a keyboard and a mouse, a microphone, which is a sound input device, and the like.

The output device 170 is a device for generation output information including a display, a printer, a speaker, which is a sound output device, and the like.

The auxiliary storage device 180 is a nonvolatile storage device capable of storing digital information such as a so-called hard disk drive, a solid state drive (SSD), and a flash memory.

Moreover, the display terminal 200, the display terminal 300, and the sensor data management device 400 have approximately the same hardware configuration as that of the maintenance operation plan calculation device 100. It should be noted that the sensor data management device 400 further includes a sensor reception device (not shown) for acquiring the output information from the predetermined sensors installed at the predetermined locations of the vehicle.

An example of the hardware configuration of the railroad maintenance system 1 according to this embodiment has been described above. However, the present invention is not limited thereto, and the railroad maintenance system 1 may be configured by using other hardware. For example, the network 30 may be a wireless network or a cellular phone network, and the sensor data management device 400 may be connected to the network 30 via a network using a power transmission line to a train or the like.

[Description of Operation]

Next, a description is made of an operation of the railroad maintenance system 1 according to this embodiment.

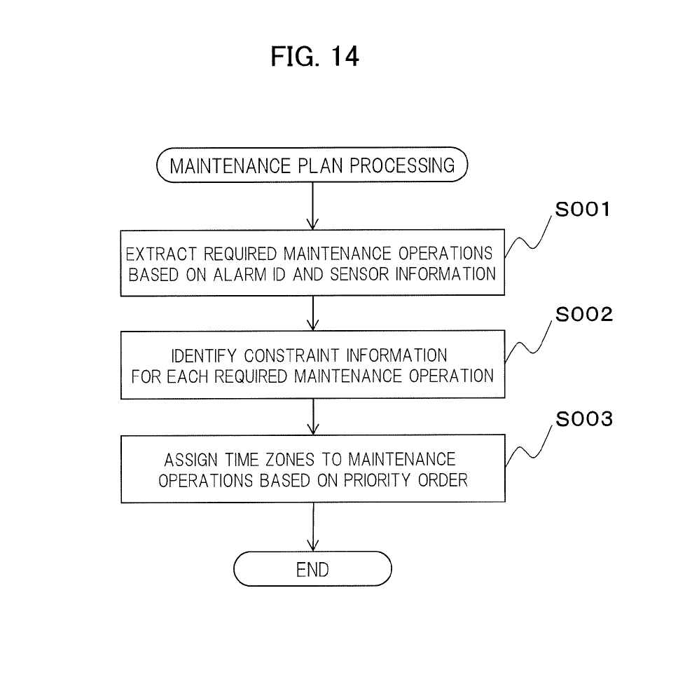

FIG. 14 is a processing flow chart of the maintenance plan processing carried out by the maintenance operation plan calculation device 100 of the railroad maintenance system 1 according to this embodiment. The maintenance plan processing is started when the maintenance operation plan calculation device 100 receives the transmission of the alarm information from the sensor data management device 400 while the maintenance operation plan calculation device 100 is activated.

First, the maintenance operation identification part 111 extracts required maintenance operations based on the alarm ID and the sensor information (Step S001). Then, the constraint information identification part 112 identifies constraint information for each of the required maintenance operations (Step S002). Then, the optimal operation plan calculation part 113 assigns time zones to the maintenance operations based on the priority order (Step S003). A description is sequentially given of detailed processing in Steps S001 to S003.

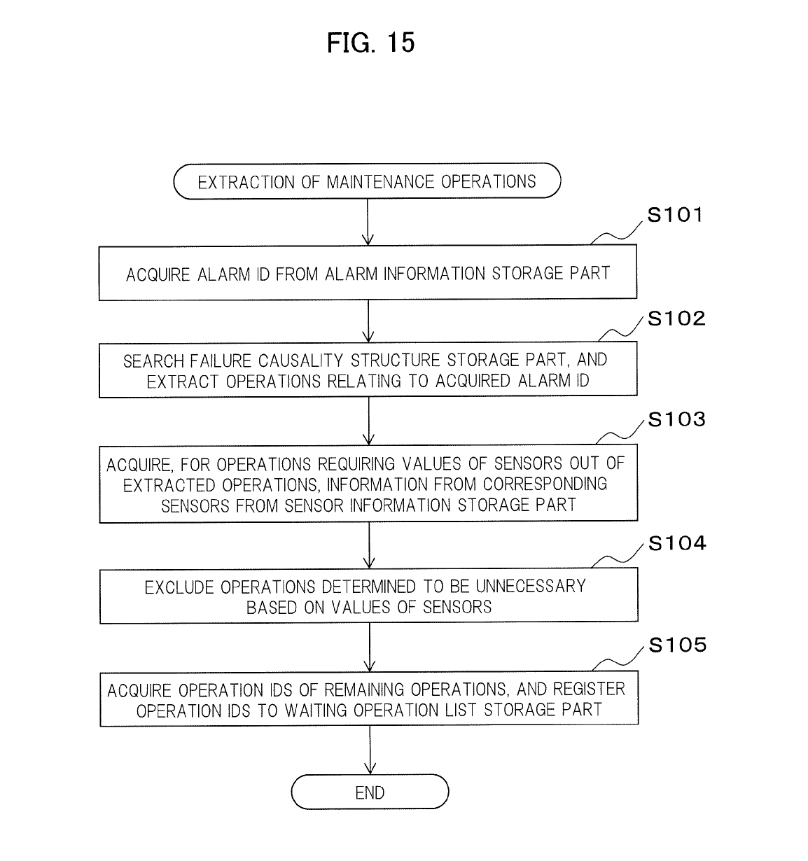

FIG. 15 is a chart illustrating a processing flow of the processing of extracting the maintenance operations corresponding to Step S001. First, the maintenance operation identification part 111 acquires an alarm ID from the alarm information storage part 422 (Step S101). Specifically, the maintenance operation maintenance part ill uses the vehicle ID of a vehicle that is a transmission source of an alarm in the received alarm information and the information on the time/date when the alarm was received to refer to the alarm information storage part 422, thereby acquiring information on a corresponding alarm ID 422c. On this occasion, the information on the time/date 422b is information for identifying the time/date of the recording on the sensor data management device 400 side, and does not always match the time/date when the maintenance operation plan calculation device 100 received the alarm. Therefore, the reference is made so as to identify the alarm at the closest time while allowing extension or shortening by a predetermined period (such as five seconds).

Then, the maintenance operation identification part 111 extracts maintenance operations relating to the alarm ID searched for and acquired in the failure causality structure storage part 122 (Step S102). Specifically, the maintenance operation identification part 111 refers to the failure causality structure storage part 122, and reads records associated with the alarm ID identified in Step S101.

Then, the maintenance operation identification part 111 acquires, for operations requiring values of sensors out of the extracted operations, the corresponding information from the sensors from the sensor information storage part 421 (Step S103). Specifically, the maintenance operation identification part 111 identifies, out of the records read in Step S102, records in which a sensor is designated in the inspection/action method 122d, and identifies the information from the sensors as information to be read. Then, the maintenance operation identification part 111 refers to the sensor information storage part 421, and acquires output information corresponding to the information to be read from the sensors corresponding to the vehicle ID and the time/date identified in Step S101. For example, the maintenance operation identification part 111 acquires information “556.2” stored in the first sensor 421c, which is the output value of the first sensor on a vehicle having a vehicle ID “V1” at “2012/05/01/12:00:00”. In other words, the maintenance operation identification part 111 acquires the output information from the sensor output at approximately the same time point as the time point of the reception of the alarm as the output information from the sensor causing the generation of the alarm.

Then, the maintenance operation identification part 111 excludes operations that are determined to be no longer necessary based on the values of the sensors from the extracted operations (Step S104). Specifically, the maintenance operation identification part 111 makes a determination for each of all the records in which the sensor is designated in the inspection/action method 122d out of the records read in Step S102 based on the information from the sensor and the determination condition 122e, and excludes the records matching in the operation ID of the subsequent operation determined not to be carried out. It should be noted that records in which the operation IDs included in the excluded records are designated in pre-operation IDs 122c are also excluded, and all records that correspond to subsequent operations associated with the excluded records are excluded.

For example, for an operation ID “J002”, which specifies the subsequent operation by using the value of the first sensor 421c, information “556.2” stored in the first sensor 421c, which is the output value of the first sensor at “2012/05/01/12:00:00” on a vehicle including “V1” in the vehicle ID, is “equal to or more than 500”, and the maintenance operation identification part 111 thus identifies the subsequent operation of the operation having “J002” in the operation ID as an operation ID “J004”. In this case, the maintenance operation identification part 111 excludes an operation ID “J005”, which is for a case in which the value of the sensor is not “equal to or more than 500”, from the records. Similarly, the maintenance operation identification part 111 uses the information “36.9”, which is the output value of the second sensor so as to specify the subsequent operation of the operation ID “J004” as an operation ID “J007” corresponding to “less than 56” in the value of the sensor, and excludes an operation ID “J006” corresponding to “equal to or more than 56” in the value of the sensor from the records.

Then, the maintenance operation identification part 111 acquires the operation IDs of the remaining operations, and registers the operation IDs to the waiting operation list storage part 126 (Step S105). Specifically, the maintenance operation identification part 111 stores each of the records read in Step S102 excluding the records excluded in Step S104 in the operation ID 126c of the waiting operation list storage part 126. Moreover, the maintenance operation identification part 111 stores the vehicle ID of the vehicle that has generated the alarm in the vehicle ID 126b of the waiting operation list storage part 126.

A description has been given of the processing flow of the processing of extracting the maintenance operations corresponding to Step S001. In other words, the maintenance operation identification part 111 identifies the maintenance operations associated with the information identifying the alarm, determines whether or not each operation with which the predetermined condition is associated out of the identified maintenance operations satisfies the predetermined condition based on the output information from the sensor, and excludes subsequent operations that do not satisfy the predetermined condition from the maintenance operations, thereby extracting the required maintenance operations. Moreover, as a result, redundant operations can be excluded from the maintenance operation plan, thereby acquiring reasonable operation content.

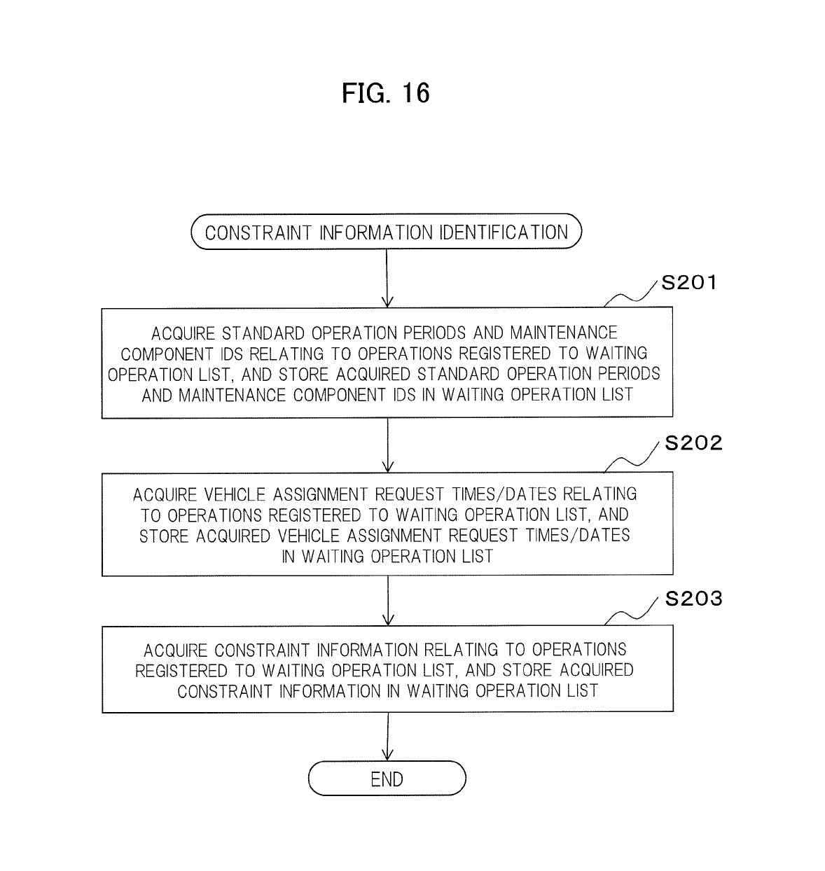

FIG. 16 is a diagram illustrating a processing flow of the constraint information identification processing corresponding to Step S002. First, the constraint information identification part 112 acquires the standard operation periods and the maintenance component IDs relating to the operations registered to the waiting operation list storage part 126, and stores the acquired standard operation periods and maintenance component IDs to the waiting operation list storage part 126 (Step S201). Specifically, the constraint information identification part 112 refers to the maintenance operation resource storage part 123 so as to acquire the standard operation period 123b and the maintenance component ID 123c for each of the operation IDs registered to the waiting operation list storage part 126. Then, the constraint information identification part 112 stores the standard operation period 126d and the maintenance component ID 126e corresponding to each of the operations registered to the waiting operation list storage part 126.

Further, the constraint information identification part 112 acquires the vehicle assignment request times/dates relating to the operations registered to the waiting operation list storage part 126, and stores the acquired vehicle assignment request times/dates (Step S202) to the waiting operation list storage part 126. Specifically, the constraint information identification part 112 refers to the vehicle assignment request time/date information storage part 127 by using the vehicle ID 126b as a key so as to acquire information on the vehicle assignment request time/date 127b and the vehicle assignment location 127c for each of the operation IDs registered to the waiting operation list storage part 126. Then, the constraint information identification part 112 stores, for each of the operations registered to the waiting operation list storage part 126, the information on the corresponding vehicle assignment request time/date 127b to the vehicle assignment request time/date 126f.

Then, the constraint information identification part 112 acquires other constraint information relating to the operations registered to the waiting operation list storage part 126, and stores the acquired constraint information to the waiting operation list storage part 126 (Step S203). Specifically, the constraint information identification part 112 refers to the constraint information storage part 124 by using the operation ID 126c as a key so as to acquire information including information on the pair operation 124b, the power supply 124c, the pneumatic pressure 124d, the facility A 124e, the facility B 124f, and the subject unit 124g for each of the operation IDs registered to the waiting operation list storage part 126. Then, the constraint information identification part 112 stores, for each of the operations registered to the waiting operation list storage part 126, the information on the corresponding pair operation 124b, power supply 124c, pneumatic pressure 124d, facility A 124e, facility B 124f, and subject unit 124g to the pair operation 126g, the power supply 126h, the pneumatic pressure 126j, the facility A 126k, the facility B 126m, and the subject unit 126n.

A description has been given of the processing flow of the constraint information identification processing corresponding to Step S002.

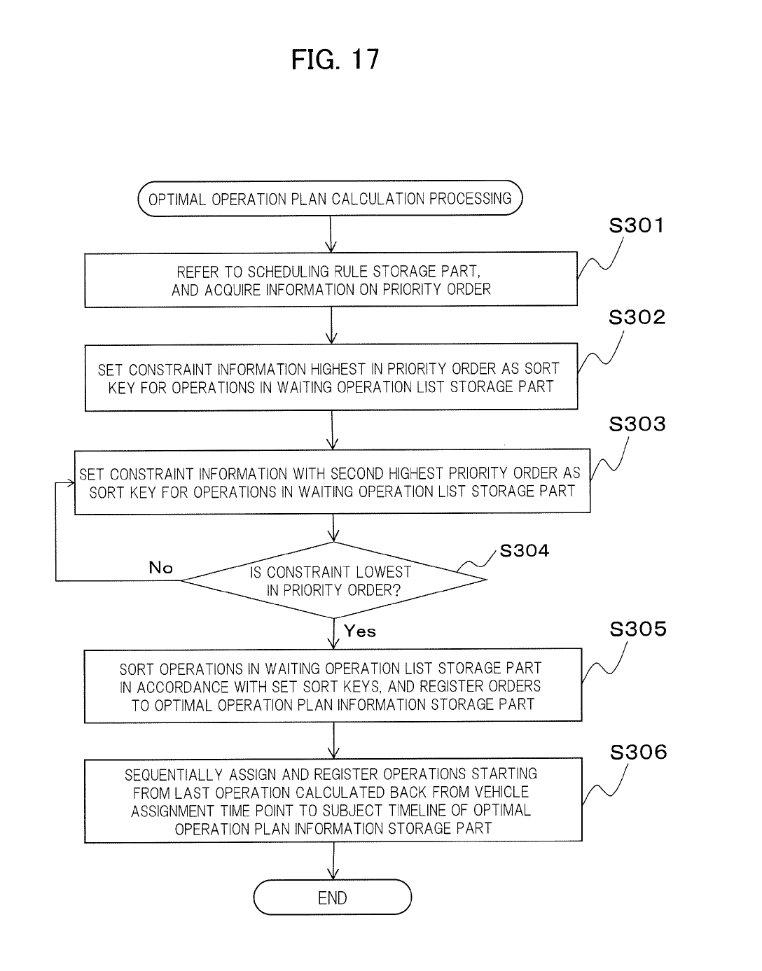

FIG. 17 is a diagram illustrating a processing flow of the optimal operation plan calculation processing corresponding to Step S003. First, the optimal operation plan calculation part 113 refers to the scheduling rule storage part 128 so as to acquire information on the priority order (Step S301). Specifically, the optimal operation plan calculation part 113 refers to the scheduling rule storage part 128 so as to read all pieces of constraint information 128b associated with the priority order 128a.

Then, the optimal operation plan calculation part 113 sets constraint information highest in the priority order as a sort key for the operations in the waiting operation list storage part 126 (Step S302).

Then, the optimal operation plan calculation part 113 sets constraint information having the second highest priority order as a sort key for the operations in the waiting operation list storage part 126 (Step S303).

Then, the optimal operation plan calculation part 113 determines whether or not the set sort key is the lowest constraint information, and when the sort key is not the lowest constraint information, returns the control to Step S303 (Step S304).

When the sort key is the lowest constraint information (“Yes” in Step S304), in other words, when, in Step S303, the optimal operation plan calculation part 113 has set all the pieces of the constraint information as the sort key in accordance with the priority order, the optimal operation plan calculation part 113 sorts the respective operations stored in the waiting operation list storage part 126 in accordance with the set plurality of sort keys, and registers the operations to the optimal operation plan information storage part 129 (Step S305). Specifically, the optimal operation plan calculation part 113 sorts the respective operations stored in the waiting operation list storage part 126 in a descending order by the key high in the priority order, sorts operations having the same order by the key with the second highest priority order, and further sorts operations having the same order by the key with the third highest priority order. This sort is repeated down to the key with the lowest priority order. Then, the optimal operation plan calculation part 113 stores the operations in the operation ID 129d, the facility A 129e, and the facility B 129f of the optimal operation plan information storage part 129 in accordance with the orders of the sorted operations. In this way, the passage of time can be associated with the maintenance operation plan.

Specifically, the optimal operation plan calculation part 113 sorts operations that satisfy constraint information “power supply ON” having the highest specified priority order “1”, in other words, operations having “1” as the value of the power supply 126h out of the operations in the waiting operation list storage part 126 in the descending order, and then sorts operations that satisfy constraint information “power supply OFF” having the second highest priority order “2” in the descending order. Further, the optimal operation plan calculation part 113 sorts, in the descending order, the facilities A 126k out of operations having “1” as the value of the power supply 126h. Still further, the optimal operation plan calculation part 113 sorts operations having “roof” as the subject unit 126n out of operations having “1” as the facility A 126k so as to be high in order. In this way, the optimal operation plan calculation part 113 sorts the waiting operations in accordance with the priority order 128a, and moves values of the operation ID 129d, the facility A 129e, and the facility B 129f to the optimal operation plan information storage part 129 based on the orders after the sort.

Then, the optimal operation plan calculation part 113 sequentially assigns and registers the operations registered to the optimal operation plan information storage part 129 starting from the last operation calculated back from the vehicle assignment time point to a subject timeline of the optimal operation plan information storage part 129 (Step S306).

Specifically, the optimal operation plan calculation part 113 sequentially identifies the start time/date and the end time/date of operations registered to the optimal operation plan information storage part 129 starting from/as the operation calculated back from the vehicle assignment request time/date in accordance with the standard operation period 126d without overlaps of the time zones, and stores the identified start time/date and end time/date respectively in the start time/date 129b and the end time/date 129c. Moreover, the optimal operation plan calculation part 113 assigns the respective operations starting from the first operation with time IDs in the ascending order, and stores the respective time IDs in the time ID 129a.

It should be noted that the optimal operation plan calculation part 113 uses information on the vehicle assignment request time/date and the vehicle assignment location, a current time point, and information on a location of the maintenance factory 13 so as to calculate a required period along a travel path from the maintenance factory 13 to the vehicle assignment location, and identifies a time point acquired by calculating back the required period from the vehicle assignment request time/date as the end time/date of the last maintenance operation. Moreover, when the start time point of the first maintenance operation out of the maintenance operations identified in this way is before a time point acquired by adding a required period necessary for a travel from the current vehicle location to the maintenance factory 13 to the current time/date, the optimal operation plan calculation part 113 determines that the maintenance plan cannot be carried out, and may output this determination to the maintenance operation plan calculation device 100 or the display terminal 200. A preparation of a feasible maintenance plan can be assisted in this way.

A description has been given of the flow of the optimal operation plan calculation processing corresponding to Step S003.

Thereafter, the maintenance operation plan output part 211 (or the maintenance operation plan output part 311) of the display terminal 200 (or the display terminal 300) acquires information in the optimal operation plan calculation part 113 in response to a request from the user, and outputs the information to a display or a printer, thereby enabling reference to the plan from the warehouse 12 or the maintenance factory 13.

The railroad maintenance system 1 to which the first embodiment of the present invention is applied has been described above with reference to the accompanying drawings. According to the first embodiment of carrying out the maintenance plan processing, the required maintenance operations can be identified by using the received alarm information and sensor information corresponding to the time/date of the generation of the alarm, and the operations can be assigned to the optimal time zones, to thereby assist the quick preparation of the maintenance plan.

The present invention is not limited to the above-mentioned first embodiment. Various modifications can be made to the above-mentioned first embodiment within the scope of technical thoughts of the present invention. For example, according to the first embodiment, the maintenance system for the railroad is the subject, but the subject is not limited to the railroad. For example, the maintenance system may be a maintenance system for moving bodies moving on a road such as shuttle buses, chartered buses, taxies, limousines, rental cars, vehicles for the car sharing, business vehicles, emergency vehicles, motorcycles, motor tricycles, vehicles for a long distance race such as a rally, and bicycles. Moreover, the maintenance system may be a maintenance system for aircrafts such as passenger airplanes and helicopters. Moreover, the maintenance system may be a maintenance system for vessels such as passenger ships, tankers, fishing boats, submarines, and sailing yachts. Moreover, the maintenance system, is not limited to that for the moving bodies, and may be a maintenance system for video devices such as satellite broadcast reception devices rented for users and home electronic appliances including cooking units such as microwave ovens. As a result of this configuration, an abnormality of a subject requiring maintenance can be detected, and repair can be prepared.

Moreover, for example, such a case that the alarm is false or temporary, and quick maintenance operations are thus not necessary is conceivable. Thus, the maintenance operation identification part 111 may acquire latest output information from the sensors at a constant interval from the sensor data management device 400 for the subject train, and determine whether or not the state requiring the alarm notification is maintained before the extraction of the maintenance operations in Step S102 of the processing of extracting the maintenance operations. In this way, maintenance operations can be avoided from being planned for a temporary abnormal state (such as a rapid temperature increase in a brake control mechanism as a result of an emergency braking), and a useless maintenance plan that does not need to be carried out can be avoided from being prepared.

Moreover, for example, such a case where an abnormality causing the transmission of an alarm is known (for example, in such a state in which occurrence of an abnormality on an air-conditioning facility of the vehicle has been known and repair has been arranged, a case where an alarm corresponding to the air-conditioning abnormality is generated) exists. In this case, in order to prevent an unnecessary maintenance plan from being prepared, in the maintenance operation plan calculation device 100, the storage part 120 includes an ignorance information storage part (ignore list) associating the vehicle ID, the alarm ID, and time limit information for identifying a period of ignoring the alarm. Then, the maintenance operation identification part 111 may determine whether or not a vehicle ID and an alarm ID match the ignore list, and whether or not an alarm generation time/date is included in the period of the ignorance before the extraction of the maintenance operations in Step S102 of the processing of extracting the maintenance operations. When the alarm generation time/date is included in the period of the ignorance, the processing of extracting the maintenance operations may be canceled. In this way, maintenance operations can be avoided from being planned for a known abnormality, and a useless maintenance plan that does not need to be carried out can be avoided from being prepared.

Moreover, for example, in the first embodiment, the maintenance subject 14 is assumed to be the train, but the maintenance subject 14 is not limited to the train. For example, various sensors such as an a vibration sensor and infrared sensor may be installed on station buildings, rails, railroad crossings, and the like, a sensor data management device for collecting information from these sensors may be arranged in a predetermined facility, and the station buildings, the rails, and the railroad crossings may be set as the maintenance subjects. In this case, the maintenance operation identification part ill may use a required period taken for a travel of an examiner from the maintenance factory 13 to the monitoring subject of the sensor and the like for the assignment to the timeline, to thereby increase an operation efficiency of inspection/maintenance for catenaries and the like.

Moreover, for example, in the first embodiment, the maintenance subject 14 is assumed to be the train, but the maintenance subject 14 is not limited to the train. For example, a portable terminal such as a smartphone may be operated as the sensor data management device 400. Additionally, a vibration sensor or the like may be provided on a device required for maintaining a living body such as a pacemaker, and when a generated pulse is abnormal, notification of abnormality generation and a detection value of the sensor is made to the carrying portable terminal such as the smartphone via a radio wave or the like. In this way, when an abnormality is found in the pacemaker, the smartphone may transmit the alarm to the maintenance operation plan calculation device 100, and the maintenance operation plan calculation device 100 may refer to the sensor value, to thereby plan required maintenance operations. For example, when the display terminal 200 is disposed at a hospital, assignment of doctors who can carry out an operation, reservation of operation facilities, and the like can be promoted before a patient arrives the hospital by referring to the maintenance operation plan.

Further, technical elements of the above-mentioned embodiment may be applied alone, or may be applied by being divided into a plurality of portions such as program parts and hardware parts.

The embodiment of the present invention has been mainly described above.

### REFERENCE SIGNS LIST

1 . . . railroad maintenance system, 30 . . . network, 100 . . . maintenance operation plan calculation device, 110 . . . calculation part, 111 . . . maintenance operation identification part, 112 . . . constraint information identification part, 113 . . . optimal operation plan calculation part, 120 . . . storage part, 122 . . . failure causality structure storage part, 123 . . . maintenance operation resource storage part, 124 . . . constraint information storage part, 125 . . . optimal operation order list storage part, 126 . . . waiting operation list storage part, 127 . . . vehicle assignment request time/date information storage part, 128 . . . scheduling rule storage part, 129 . . . optimal operation plan information storage part, 200 . . . display terminal, 211 . . . maintenance operation plan output part, 300 . . . display terminal, 311 . . . maintenance operation plan output part, 400 . . . sensor data management device, 411 . . . sensor data processing part, 412 . . . alarm data processing part, 421 . . . sensor information storage part, 422 . . . alarm information storage part

1. A maintenance device, comprising:
a maintenance operation identification part configured to acquire, for an alarm received via a network, from another device that has transmitted the alarm via the network, information for identifying the alarm and information output from a sensor causing generation of the alarm, and extract required maintenance operations based on the information for identifying the alarm and the information output from the sensor;
a constraint information identification part configured to identify constraint information including a facility required for each of the required maintenance operations; and
an optimal operation plan calculation part configured to identify an execution order of the required maintenance operations based on a priority order in the constraint information, and assign predetermined time zones, to thereby generate a maintenance operation plan.

2. A maintenance device according to claim 1, further comprising a failure causality structure storage part configured to store failure causality structure information in which one or a plurality of maintenance operations are associated with the information for identifying the alarm, wherein:
in the failure causality information, a predetermined condition is associated with the maintenance operation for which a subsequent operation exists when the information output from the sensor satisfies the predetermined condition; and
the maintenance operation identification part identifies the one or the plurality of maintenance operations associated with the information for identifying the alarm, determines whether or not each operation with which the predetermined condition is associated out of the identified one or plurality of maintenance operations satisfies the predetermined condition based on the information output from the sensor, and excludes a subsequent operation that does not satisfy the predetermined condition from the one or the plurality of maintenance operations, to thereby extract the required maintenance operations.

3. A maintenance device according to claim 1, wherein the maintenance operation identification part sets the information output from the sensor output at approximately the same time point as a time point of reception of the alarm as the information output from the sensor causing the generation of the alarm.

4. A maintenance device according to claim 1, further comprising a scheduling rule storage part configured to store information including a priority order of types of a constraint included in the constraint information,
wherein the optimal operation plan calculation part identifies the execution order of the required maintenance operations based on the priority order stored in the scheduling rule storage part.

5. A maintenance device according to claim 1, wherein the maintenance operation identification part acquires the information output from the sensor at a constant interval, and cancels extraction of the required maintenance operations when a state requiring an alarm notification is not maintained.

6. A maintenance device according to claim 1, further comprising an ignorance information storage part configured to associate information for identifying a period during which the alarm is to be ignored with the information for identifying the alarm,
wherein the maintenance operation identification part cancels extraction of the required maintenance operations when a time/date of a transmission of the alarm acquired from the another device matches the period during which the alarm is to be ignored.

7. A maintenance system, comprising:
a maintenance device capable of connecting to a network; and
an alarm generation device capable of communicating to/from the maintenance device via the network,
wherein the maintenance device comprises:
a maintenance operation identification part configured to acquire, for an alarm received from the alarm generation device via the network, from the alarm generation device from the alarm generation device via the network, information for identifying the alarm and information output from a sensor causing generation of the alarm, and extract required maintenance operations based on the information for identifying the alarm and the information output from the sensor;
a constraint information identification part configured to identify constraint information including a facility required for each of the required maintenance operations; and
an optimal operation plan calculation part configured to identify an execution order of the required maintenance operations based on a priority order in the constraint information, and assign predetermined time zones, to thereby generate a maintenance operation plan.

8. A program for causing a computer to carry out procedures for generating a maintenance operation plan,
the program causing the computer to function as control means,
the program causing the control means to carry out:
a maintenance operation identification procedure of acquiring, for an alarm received via a network, from another device that has transmitted the alarm via the network, information for identifying the alarm and information output from a sensor causing generation of the alarm, and extracting required maintenance operations based on the information for identifying the alarm and the information output from the sensor;
a constraint information identification procedure of identifying constraint information including a facility required for each of the required maintenance operations; and
an optimal operation plan calculation procedure of identifying an execution order of the required maintenance operations based on a priority order in the constraint information, and assigning predetermined time zones, to thereby generate a maintenance operation plan.
